(19) United States
(12) Patent Application Publication
(10) Pub. No.: US 2007/0088577 A1
(43) Pub. Date: Apr. 19, 2007

(54) METHODS AND SYSTEMS FOR MEASURING PHYSICIAN ADHERENCE TO GUIDELINES

(76) Inventors: Barry L. Carter, Coralville, IA (US); Jessica Milchak, Fort Collins, CO (US); Gail Ardery, Iowa City, IA (US); Henry R. Black, New York, NY (US); George L. Bakris, Munster, IN (US); Daniel W. Jones, Hazelhurst, MS (US)

Correspondence Address: NEEDLE & ROSENBERG, P.C., SUITE 1000, 999 PEACHTREE STREET, ATLANTA, GA, 30309-3915, US

(21) Appl. No.: 11/463,733

(22) Filed: Aug. 10, 2006

Related U.S. Application Data
(60) Provisional application No. 60/707,081, filed on Aug. 10, 2005.

(51) Int. Cl. G06F 19/00

(52) U.S. Cl. 705/3

(57) ABSTRACT

Methods and systems for determining and comparing physician adherence to guidelines are disclosed. The methods can comprise receiving patient data, scoring criteria, determining domain and overall scores, and comparing said scores. The methods can comprise receiving patient data, scoring criteria, determining overall scores, and comparing said scores. The methods provide a list of criteria and a scoring algorithm for deriving adherence scores useful for evaluating physician care. The methods allow for the comparison of standards of care between physicians, facilities, and between classes of patients.

### CROSS REFERENCE TO RELATED PATENT APPLICATION

This application claims priority to U.S. Provisional Application No. 60/707,081 filed Aug. 0, 2005, herein incorporated by reference in its entirety.

### ACKNOWLEDGEMENTS

This invention was made with Government support under Contract No. R01 HL070740 awarded by the National Heart, Lung and Blood Institute. The Government has certain rights in the invention.

### BACKGROUND OF THE INVENTION

Practice guidelines serve as useful tools for clinical decision-making. Guidelines are used to reduce practice variation, guide appropriateness, and measure quality of care. Ultimately, the goal of a guideline is to improve patient outcomes through a change to evidence-based physician practices. Unfortunately, substantial gaps have been documented between the development and dissemination of consensus statements and their implementation in practice. In short, clinical practice guidelines do not consistently change physician behavior.

Although the National Heart, Lung, and Blood Institute (NHLBI) has published seven guidelines for the treatment of hypertension, control of high blood pressure remains suboptimal. An estimated 40% of the 50 million persons in the United States with hypertension remain untreated, and 66% of hypertensive patients have blood pressure values that are not controlled to the recommended levels. Many studies have concluded that physician adherence to hypertension guidelines has been low. Poor blood pressure control can be connected to poor adherence to hypertension guidelines. Therefore, physician adherence to hypertension guidelines must be assessed and compared accurately.

### SUMMARY OF THE INVENTION

Methods and systems for determining and comparing physician adherence to guidelines are disclosed. Guidelines can include, for example, standards of care directed toward a physical or mental condition such as hypertension, diabetes, schizophrenia, and the like. Hypertension will be described herein by way of example. The methods can comprise receiving patient data, scoring criteria, determining domain and overall scores, and comparing said scores. The methods can comprise receiving patient data, scoring criteria, determining overall scores, and comparing said scores. The methods provide a list of criteria and a scoring algorithm for deriving adherence scores useful for evaluating physician care. The methods are an improvement over earlier systems for many reasons, including, use of explicit criteria to evaluate adherence, evaluation of multiple aspects of care that extend beyond prescriptive practice, and the incorporation of measures for patient populations with specific co-morbidities.

The methods make use of criteria and a complex scoring algorithm for determining adherence scores. Certain criteria apply to all patients with hypertension, while others apply only in certain care situations or only to patients with co-morbid conditions. As all criteria may not apply to all persons with hypertension, adherence scores are able to reflect the number of criteria a physician met in caring for a given patient, tempered by the number of criteria applicable to that patient.

The methods disclosed overcome weaknesses of earlier attempts to address physician adherence to hypertension guidelines. One such weakness overcome is addressing patients with co-morbid conditions. The present methods address hypertension care that is given to patients with specific co-morbid conditions, including diabetes, heart failure, myocardial infarction, coronary artery disease, stroke or TIA and chronic renal disease.

Additional advantages will be set forth in part in the description which follows, and in part will be obvious from the description, or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate several embodiments and together with the description, serve to explain the principles of the methods and systems.

FIG. 1 is a logic flow diagram illustrating the basic steps of an exemplary method.

FIG. 2 is a logic flow diagram illustrating the basic steps of an exemplary criterion scoring method.

FIG. 3 is a logic flow diagram illustrating the basic steps of an exemplary domain and overall score determination method.

FIG. 4 is an illustrative operating environment.

### DETAILED DESCRIPTION OF THE INVENTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “a criterion” includes mixtures of criteria; reference to “a criterion” includes mixtures of two or more such criteria, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. For example, the phrase “optionally substituted partitions” means that partitions may or may not be substituted and that the description includes both unsubstituted partitions and partitions where there is substitution.

As used throughout, by a “subject” or “patient” is meant an individual. Thus, the “subject” can include domesticated animals, such as cats, dogs, etc., livestock (e.g., cattle, horses, pigs, sheep, goats, etc.), laboratory animals (e.g., mouse, rabbit, rat, guinea pig, etc.) and birds. In one aspect, the subject is a mammal such as a primate or a human. The term does not denote a particular age or sex. Thus, adult and newborn subjects, as well as fetuses, whether male or female, are intended to be covered.

“Percent of adherence” is defined as a ratio determined by the number of applicable criteria or standards of care that physicians met.

Finally, the methods and systems are not limited to a specific medical condition or disease state. Although the specification focuses on a system for evaluating physician adherence to guideline-recommended care practices for patients with hypertension, parallel criteria and scoring systems can be delineated to evaluate adherence to guideline-recommended care practices for any number of medical conditions or disease states.

The present methods and systems may be understood more readily by reference to the following detailed description of preferred embodiments of the methods and systems and the Examples included therein and to the Figures and their previous and following description.

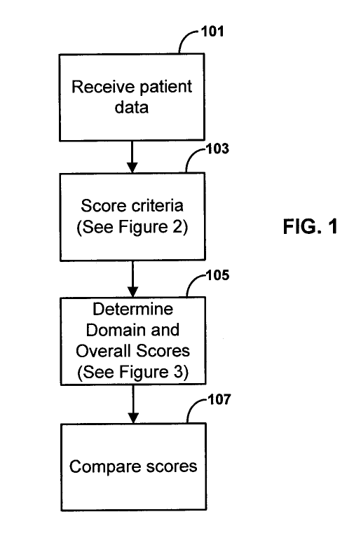

As shown in FIG. 1, block 101, the patient data is received. Examples of the type of patient data received are described in detail below. The patient data can be received from written medical records that are reviewed and manually entered into an electronic system. The patient data can also be received from medical records already in electronic form. The patient data can be retrieved from multiple sources, such as hospitals, clinics, and other healthcare facilities.

What follows are examples of data that can be used in the methods disclosed herein. Portions of the data have been assigned a line number so as to make the method implementation more efficient. The data is not restricted to a specific quantity of data entries defined by the line numbers. For example, assessment data comprises lines 39 through 58, however, assessment data can comprise more than the twenty line entries from 39 to 58. The line numbers are provided for exemplary purposes only and to aid in data reference.

[image]

[image]

[image]

[image]

[image]

The data can comprise assessment data. Lines 39 through 58 can comprise data related to the reason for a patient's visit, data related to or indicative of the specific health condition for which care is being evaluated, and data that reflect the physician's attention to that health condition. The data can be restricted by specifying either the length of time that an evaluation of care will span or the total number of visits that will be examined.

[image]

The data can comprise data related to treatment for a specific health condition. Lines 59 through 96 can comprise data related to pharmacological treatments prescribed for the specific health condition and data related to lifestyle changes that are recommended for that health condition.

[image]

Codes for lines 59-96:
ˆIf Yes: complete a line for the acute visit or referral.
* Drug Treatment Codes:
   a=drug started
   b=dose increased
   c=dose decreased
   d=drug discontinued
   e=no change in drug rx
@Dose 1 and Dose 2: Total daily dose in milligrams. (Dose 2 permits coding for combination agents.)
#Lifestyle Changes Discussed (select all that apply):
   a=weight reduction
   b=DASH plan
   c=sodium restriction
   d=increased activity
   e=decreased alcohol
   f=other (list in column i)
   g=none were discussed

Data from laboratory tests can be used. The data can be from tests conducted within a set time period, for example, 6 months, 12 months, 18 months, or 24 months. All laboratory tests that are pertinent in treating the specific health condition in question should be included. Relevant laboratory tests for evaluating physician adherence to hypertension guidelines can include, but are not limited to, Bicarbonate, Blood urea nitrogen (BUN), Calcium, Cholesterol (total), C reactive protein (CRP), Creatinine (serum), Glomerular Filtration Rate (GFR), Glucose (fasting), HDL, Hematocrit, Homocysteine, LDL, Potassium, Sodium, Triglycerides, and Urine microalbumin. Each test can be assigned a unique test code to facilitate electronic processing of patient data. The date the test was conducted can be included in data from laboratory tests. Other tests and variations of tests capable of generating data for use in the present method will be apparent to one skilled in that art. Lines 97 through 146 can comprise data from laboratory tests.

[image]

Data from acute care visits and referrals can be used. Lines 147 through 156 can comprise data from acute care visits and referrals. These data are included in order to describe all the care a patient has received in order to put the specific care being evaluated into context. These data comprise the date of acute care visits and referrals that are related to the specific health condition in question and pharmacological treatments that were prescribed at those visits.

[image]

Codes for lines 147-156:
*Drug Treatment Codes (fill in one letter per line):
   a=drug started
   b=dose increased
   c=dose decreased
   d=drug discontinued
   e=no change in drug treatment
@Dose 1 and Dose 2: Total daily dose in milligrams.

The patient data received in step 101 of FIG. 1 can then be used to evaluate the care that physicians delivered against a set of explicit criteria developed to reflect standards of care. Such standards typically are published by an organization of healthcare professionals in the form of “guidelines.” Criteria that can be used for evaluating care for patients with hypertension are described below. Modifications to these criteria, as known to one skilled in the art, are specifically contemplated. These criteria are provided as an example of the types of criteria that can be used. Each criterion can have a criterion score. The criterion score can be unassigned, 0 or 1. Each criterion can have an associated weight to indicate the relative value of each criterion. The individual criteria scores enable an evaluation to identify problems with detailed aspects of care. In addition, the criteria described herein can be grouped into four domains that reflect broad aspects of medical care: diagnosis, pharmacological treatment, follow-up of care, and laboratory monitoring. Grouping criteria into these domains enables an evaluation to identify problems in these broad aspects of care. The methods and systems described herein can utilize combinations of the criteria, as certain sub-groups of criteria may prove to be a more effective indicator in various situations. These sub-groups can be created by one skilled in the art to fit various situations. The methods and systems can utilize an overall score, one or more domain scores, and combinations thereof.

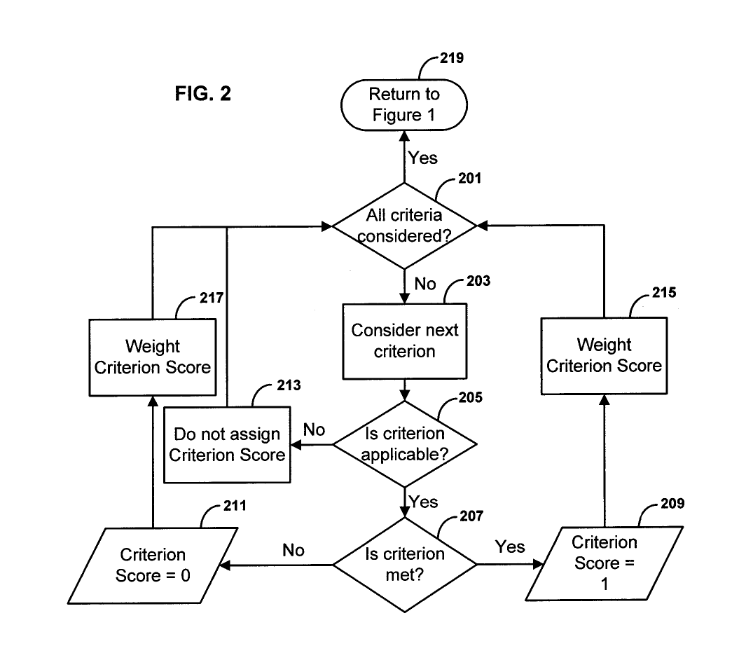

The individual patient data obtained in Box 101 is scored against the specified explicit criteria, as indicated in block 103 of FIG. 1. Block 103 is described in more detail in FIG. 2 beginning at block 201. At block 201, a check is performed to determine if all the criteria have been considered. If the criteria have not all been considered, the next criterion will be considered, as indicated in block 203. A check will be performed to determine if the criterion is applicable to the patient (block 205). If the criterion is not applicable to the patient, the criterion score will be unassigned (block 213) and the method will return to check if all criteria have been considered (block 201). If the criterion is applicable, a check will be performed to determine if the criterion is met, as indicated in block 207. This determination is different for each criterion and is described in detail in the paragraphs that follow. The present method is described in the context of care that is provided to patients with hypertension, but is not limited to such context. If the criterion is met, a raw criterion score is set equal to one (block 209), the criterion score is weighted (block 215) by multiplying the raw criterion score by the weight assigned to the score and the method returns to block 201 to check if all criteria have been considered. If, however, at block 207, the criterion is not met, a raw criterion score of zero (block 211) will be assigned, the criterion score is weighted (block 217) by multiplying the raw criterion score by the weight assigned to the score; in the present example, a criterion score of zero will always result in a weighted criterion score of zero. Once the weighted criterion score is obtained, the method can proceed to block 201 to check if all criteria have been considered. At block 201, if all the criteria have been considered, the method moves to block 105 of FIG. 1 (block 219) to determine domain and overall scores.

What follows is a detailed description of exemplary criteria that can be employed to evaluate care provided to patients with hypertension. The criterion's weight is indicated by Wt=x, wherein x is the weight of the criterion. The criteria refer to line numbers given above in the description of data that can be used in evaluating care provided to patients with hypertension.

Diagnosis Domain

The criteria in the diagnosis domain comprise detailed aspects of care related to obtaining a comprehensive medical history and establishing a goal outcome of care for patients with hypertension.

[image]

[image]

[image]

[image]

Drug Therapy Domain

The criteria in the drug therapy domain comprise detailed prescriptive practices for patients with hypertension, including several subgroups of patients that have other health conditions related to or relevant in the treatment of hypertension.

[image]

| ¹Thiazide Diuretics | | | | ²Loop Diuretics |
|---|---|---|---|---|
| 102 | 213 | 314 | 613 | 103 |
| 104 | 214 | 315 | 614 | 106 |
| 105 | 215 | 316 | 706 | 113 |
| 107 | 216 | 317 | 802 | |
| 108 | 217 | 608 | 803 | |
| 109 | 218 | 609 | 804 | |
| 110 | 311 | 610 | | |
| 111 | 312 | 611 | | |
| 112 | 313 | 612 | | |

[image]

[image]

[image]

[image]

[image]

[image]

Follow-Up Domain

The criteria in the follow-up domain evaluate the frequency and intensity of care when a medical condition (for example, hypertension) is not controlled.

Criteria 11, 13, 14, and 15 can be calculated for multiple clinic visits and can be limited to those visits in which the medical condition in question was addressed (column h=Yes on lines 39-58) These visits can also be limited to a specific time period, that will vary depending on the purpose of the evaluation of care.

[image]

[image]

[image]

Laboratory Monitoring Domain

Criteria in the laboratory monitoring domain comprise specific laboratory tests that are pertinent to managing the health condition in question. The time period specified for the laboratory monitoring to have been completed, 12 months for most criteria listed as examples below, can vary depending on the health care condition and the specific laboratory test. The criteria listed below are disclosed as examples of criteria pertinent to managing patients with hypertension.

[image]

[image]

Patient Outcome Criteria

Many evaluations of care will need to measure one or more outcomes of care. These outcomes should not be included when calculating overall adherence scores or domain scores. However, outcome scores are important to measure in order to determine whether physician adherence to guideline recommendations is related to patient outcomes. Criterion 12 below is formulated as an exemplary outcome measure for patients with hypertension.

[image]

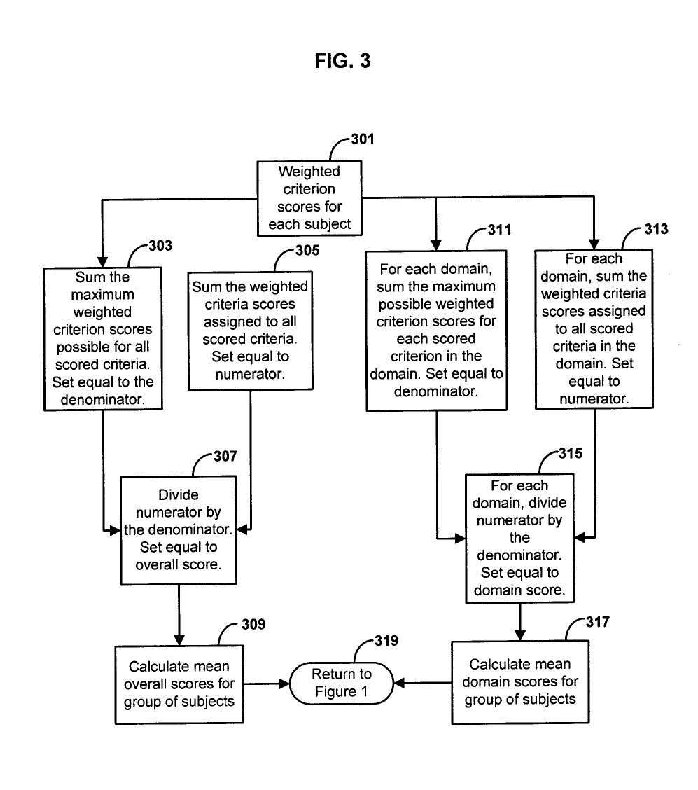

The next step of the method is to determine the domain scores and the overall adherence scores, indicated by block 105 of FIG. 1. Alternatively, the method can determine solely overall scores, solely one or more domains scores, or both overall and one or more domain scores. The details of block 105 are illustrated in FIG. 3, beginning with block 301. In block 301 the weighted criteria scores for each patient are received. Determining the score for each domain involves the following steps. First, sum the maximum weighted criterion scores (either 1 or 2 in this example) possible for each scored criterion in the domain, yielding a maximum possible weighted score for the domain, and set equal to the denominator (block 311). Then sum the actual weighted criterion scores assigned for each criterion in the domain and set equal to the numerator (block 313). The numerator is divided by the denominator and set equal to the domain score for that particular domain (block 315). The domain score can reflect the percent of applicable recommended care practices in that domain that a patient actually received. A mean domain score can be calculated for a group of patients (block 317) by summing all of the patients scores for a specific domain and dividing by the number of patients with a score in that domain. The mean domain scores are then returned (block 319) to block 107 in FIG. 1 for comparison.

Determining the overall adherence score comprises a parallel set of steps. First, sum the maximum weighted criterion scores (either 1 or 2 in this example) possible for every scored criterion, yielding a maximum possible weighted overall adherence score and set equal to the denominator (block 303). Then sum the actual criterion weighted scores for all scored criteria and set equal to the numerator (block 305). The numerator is divided by the denominator and set equal to the overall adherence score for that particular patient (block 307). The overall adherence score can reflect the percent of applicable recommended care practices that a patient actually received. The mean overall adherence score can be calculated for a group of patients (block 309) by summing the overall scores and dividing by the number of patients. The mean overall score is then returned (block 319) to block 107 in FIG. 1 for comparison.

In block 107 of FIG. 1, the mean overall adherence scores and the mean domain scores are compared. Mean overall and domain scores can be compared for any defined groups of patients. For example, mean scores could be calculated for the patients of individual physicians in a practice or in a hospital. The mean scores could then be compared across the physicians. Similarly, mean scores could be calculated for all of the patients in individual clinics or hospitals. The mean scores could then be compared across the clinics or hospitals as a benchmarking tool.

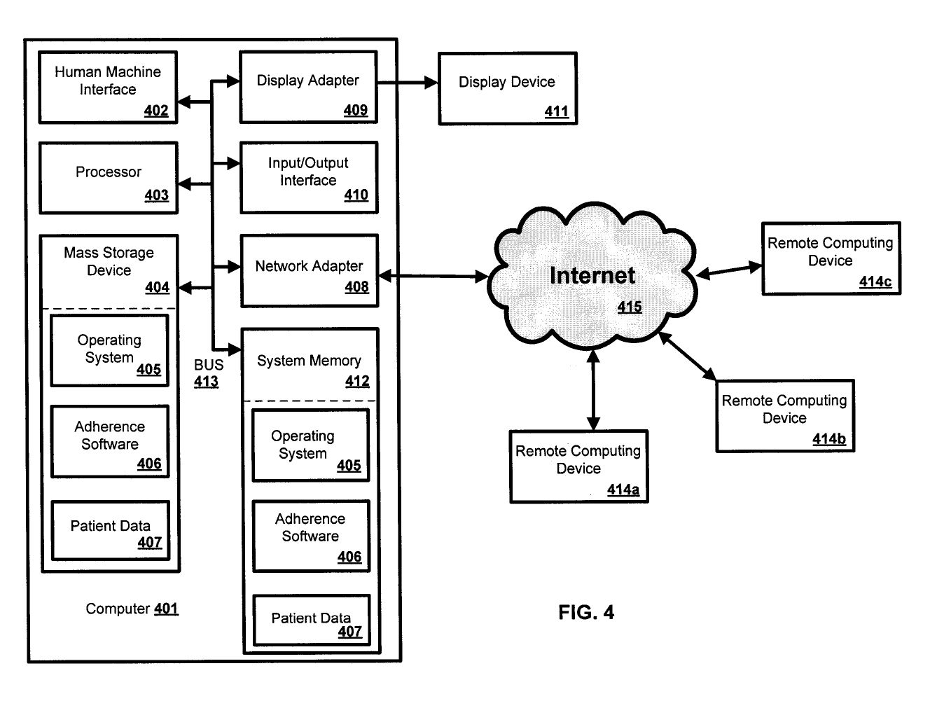

FIG. 4 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The systems and methods of the present invention can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

In another aspect, the systems and methods can be described in the general context of computer instructions, such as program modules, being executed by a computer. Generally, program modules comprise routines, programs, objects, components, data structures, etc. that perform particular tasks or implement particular abstract data types. The systems and methods can also be practiced in distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 401. The components of the computer 401 can comprise, but are not limited to, one or more processors or processing units 403, a system memory 412, and a system bus 413 that couples various system components including the processor 403 to the system memory 412.

The system bus 413 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 413, and all buses specified in this description can also be implemented over a wired or wireless network connection and each of the subsystems, including the processor 403, a mass storage device 404, an operating system 405, adherence software 406, patient data 407, a network adapter 408, system memory 412, an Input/Output Interface 410, a display adapter 409, a display device 411, and a human machine interface 402, can be contained within one or more remote computing devices 414a,b,c at physically separate locations, connected through buses of this form, in effect implementing a fully distributed system.

The computer 401 typically comprises a variety of computer readable media. Exemplary readable media can be any available media that is accessible by the computer 401 and comprises, for example and not meant to be limiting, both volatile and non-volatile media, removable and non-removable media. The system memory 412 comprises computer readable media in the form of volatile memory, such as random access memory (RAM), and/or non-volatile memory, such as read only memory (ROM). The system memory 412 typically contains data such as patient data 407 and/or program modules such as operating system 405 and adherence software 406 that are immediately accessible to and/or are presently operated on by the processing unit 403.

In another aspect, the computer 401 can also comprise other removable/non-removable, volatile/non-volatile computer storage media. By way of example, FIG. 1 illustrates a mass storage device 404 which can provide non-volatile storage of computer code, computer readable instructions, data structures, program modules, and other data for the computer 401. For example and not meant to be limiting, a mass storage device 404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 404, including by way of example, an operating system 405 and adherence software 406. Each of the operating system 405 and adherence software 406 (or some combination thereof) can comprise elements of the programming and the adherence software 406. Patient data 407 can also be stored on the mass storage device 404. Patient data 407 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 401 via an input device (not shown). Examples of such input devices comprise, but are not limited to, a keyboard, pointing device (e.g., a “mouse”), a microphone, a joystick, a scanner, and the like. These and other input devices can be connected to the processing unit 403 via a human machine interface 402 that is coupled to the system bus 413, but can be connected by other interface and bus structures, such as a parallel port, game port, an IEEE 1394 Port (also known as a Firewire port), a serial port, or a universal serial bus (USB).

In yet another aspect of the present invention, a display device 411 can also be connected to the system bus 413 via an interface, such as a display adapter 409. It is contemplated that the computer 401 can have more than one display adapter 409 and the computer 401 can have more than one display device 411. For example, a display device can be a monitor, an LCD (Liquid Crystal Display), or a projector. In addition to the display device 411, other output peripheral devices can comprise components such as speakers (not shown) and a printer (not shown) which can be connected to the computer 401 via Input/Output Interface 410.

The computer 401 can operate in a networked environment using logical connections to one or more remote computing devices 414a,b,c. By way of example, a remote computing device can be a personal computer, portable computer, a server, a router, a network computer, a peer device or other common network node, and so on. Logical connections between the computer 401 and a remote computing device 414a,b,c can be made via a local area network (LAN) and a general wide area network (WAN). Such network connections can be through a network adapter 408. A network adapter 408 can be implemented in both wired and wireless environments. Such networking environments are conventional and commonplace in offices, enterprise-wide computer networks, intranets, and the Internet 415.

For purposes of illustration, application programs and other executable program components such as the operating system 405 are illustrated herein as discrete blocks, although it is recognized that such programs and components reside at various times in different storage components of the computing device 401, and are executed by the data processor(s) of the computer. An implementation of adherence software 406 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems of the present invention can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

The processing of the disclosed systems and methods of the present invention can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The method disclosed herein was used to: 1) measure physician adherence to national guidelines for the management of hypertension and 2) compare hypertension care in patients with controlled and uncontrolled blood pressure (BP). The method disclosed was utilized to determine physician adherence when treating elderly and non-elderly patients to national hypertension guidelines written by The Seventh Joint National Committee on Prevention, Detection, Evaluation and Treatment of High Blood Pressure (JNC-7), (Chobanian, A V, Bakris, G L, Black, H R, Cushman, W C, Green, L A, Izzo, J L Jr, Jones, D Q, Materson, B J, Oparil, S, Wright, J T Jr, Rocella, E J and the National High Blood Pressure Education Program Coordinating Committee, Seventh Report of the Joint National Committee on Prevention, Detection, Evaluation, and Treatment of High Blood Pressure. Hypertension. 2003;42:1206-1252, herein incorporated by reference in its entirety) and sponsored by the National Heart, Lung and Blood Institute. Abstracts were constructed from medical records of patients at the Veterans Administration Medical Center in Iowa City, Iowa and seven university-affiliated family medicine clinics throughout Iowa. Abstracts included patient demographics, medications, medical conditions, laboratory results, clinic visits and consults related to hypertension. The method was used to score adherence to each applicable criterion. Scores for each domain and an overall adherence score were calculated for each patient, with a higher score indicating greater adherence, (range 0-100%). The sample included 177 men and women with controlled (n=33) and uncontrolled (n=144) hypertension (average age=64.9 years; range=29-90).

Across all subjects, the mean adherence score was significantly higher for patients with controlled blood pressures than for patients with uncontrolled blood pressures (60.7 vs. 54.3, p=0.043). There was also a significant difference between the mean adherence scores for patients <65 years old with controlled (68.4) vs. uncontrolled (53.3) BP (p<0.007). However, the difference in adherence scores for patients >65 years of age with controlled (56.3) vs. uncontrolled (55.2) BP was not significant (p<0.678). Overall, a 10% increase in the adherence score was associated with an 18% increase in the odds of blood pressure control (OR=1.18; p=0.109). For patients <65 years old, there was a significant association between adherence score and the odds of having controlled blood pressure (OR=1.63; p=0.028). There were no differences in the individual domain scores between patients with controlled and uncontrolled blood pressures.

These findings provide preliminary evidence that more adherent processes of care are associated with blood pressure control. In addition, the adherence tool provides a quantitative, numerical evaluation of the care provided to an individual patient. Physicians, researchers and institutions can use the tool to assess overall practice and direct changes to areas of care in most need of improvement.

Throughout this application, various publications are referenced. The disclosures of these publications in their entireties are hereby incorporated by reference into this application in order to more fully describe the state of the art to which this invention pertains.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for measuring physician adherence to a standard of care guideline, comprising the steps of:
receiving patient data;
scoring the patient data according to a list of criteria developed to reflect standards of care, wherein the scoring step generates a plurality of criterion scores;
processing the criterion scores for at least one domain to determine mean domain scores;
processing the criterion scores to determine mean overall scores; and
comparing the mean domain scores and the mean overall scores for evaluating physician adherence to the standard of care guideline.

2. The method of claim 1, wherein the patient data is data related to a specific health condition for which the patient's care is being evaluated.

3. The method of claim 1, wherein the at least one domain is selected from a group consisting of:
diagnosis;
pharmacological treatment;
follow-up of care; and
laboratory monitoring.

4. The method of claim 1, wherein each criterion is individually considered and:
is not assigned a score if the criterion is not applicable to the patient;
is assigned a score greater than zero if a criterion is applicable to the patient and if the criterion is met; and
is assigned a score equal to zero if a criterion is applicable to the patient and if the criterion is not met.

5. The method of claim 4, further comprising the step of weighting the criterion score by a weight assigned to the criterion.

6. The method of claim 5, wherein processing a domain score comprises:
summing the actual weighted criterion scores assigned for each criterion in the domain; and
dividing the result by the sum of the maximum possible weighted score for the domain.

7. The method of claim 5, wherein processing an overall score comprises:
summing the actual weighted criterion scores assigned for all scored criteria; and
dividing the result by the sum of the maximum possible weighted criterion scores for every scored criterion.

8. The method of claim 1, wherein the mean domain score is calculated by summing all of the patients' domain scores for a domain and dividing by the number of patients with a score in that domain and the mean overall score is calculated by summing the patients' overall scores and dividing by the number of patients.

9. The method of claim 1, wherein mean overall scores and mean domain scores are compared for defined groups of patients.

10. A method for measuring physician adherence to a standard of care guideline, comprising the steps of:
receiving patient data;
scoring the patient data according to a list of criteria developed to reflect standards of care, wherein the scoring step generates a plurality of criterion scores;
processing the criterion scores to determine mean overall scores; and
comparing the mean overall scores for evaluating physician adherence to the standard of care guideline.

11. The method of claim 10, further comprising:
processing criterion scores for at least one domain to determine mean domain scores; and
comparing the mean domain scores for evaluating physician care.

12. The method of claim 10, wherein the patient data is data related to a specific health condition for which the patient's care is being evaluated.

13. The method of claim 11, wherein the at least one domain is selected from a group consisting of:
diagnosis;
pharmacological treatment;
follow-up of care; and
laboratory monitoring.

14. The method of claim 10, wherein each criterion is individually considered and:
is not assigned a score if the criterion is not applicable to the patient;
is assigned a score greater than zero if a criterion is applicable to the patient and if the criterion is met; and
is assigned a score equal to zero if a criterion is applicable to the patient and if the criterion is not met.

15. The method of claim 10, further comprising the step of weighting the criterion score by a weight assigned to the criterion.

16. The method of claim 11, wherein processing a domain score comprises:
summing the actual weighted criterion scores assigned for each criterion in the domain; and
dividing the result by the sum of the maximum possible weighted score for the domain.

17. The method of claim 10, wherein processing an overall score comprises:
summing the actual weighted criterion scores assigned for all scored criteria; and
dividing the result by the sum of the maximum possible weighted criterion scores for every scored criterion.

18. The method of claim 11, wherein the mean domain score is calculated by summing all of the patients' domain scores for a domain and dividing by the number of patients with a score in that domain and the mean overall score is calculated by summing the patients' overall scores and dividing by the number of patients.

19. The method of claim 11, wherein mean overall scores and mean domain scores are compared for defined groups of patients.

20. A computer readable medium with computer executable instructions embodied thereon capable of performing a method comprising the steps of:
receiving patient data;
scoring the patient data according to a list of criteria developed to reflect standards of care, wherein the scoring step generates a plurality of criterion scores;
processing the criterion scores for at least one domain to determine mean domain scores;
processing the criterion scores to determine mean overall scores; and
comparing the mean domain scores and the mean overall scores for evaluating physician adherence to the standard of care guideline.
